(19) United States
(12) Patent Application Publication
(10) Pub. No.: US 2019/0390426 A1
(43) Pub. Date: Dec. 26, 2019

(54) FERRY SLIP

(71) Applicant: JaLo Consulting AS, Longva (NO)

(72) Inventor: Jan Arne Longva, Longva (NO)

(21) Appl. No.: 16/465,284

(22) PCT Filed: Nov. 16, 2017
(86) PCT No.: PCT/NO2017/050295

§ 371 Date: May 30, 2019

(30) Foreign Application Priority Data
Dec. 2, 2016 (NO) 20161923

(51) Int. Cl. E02B 3/26; E01D 15/24; F15B 1/24

(52) U.S. Cl. CPC E02B 3/26; F15B 1/24; E01D 15/24

(57) ABSTRACT

A ferry slip (100) comprising a vehicle driveway (41,42) arranged on a quayside (60), the ferry slip (100) comprising an elongate fluid cylinder unit (20) connected to the quayside (60) and extending longitudinally away from the quayside (60) in a seawards direction (x), the fluid cylinder unit (20) having a support element (10) at its seawards end, the fluid cylinder unit (20) fluidly connected to an accumulator unit (70) via a fluid distribution system (80). There is also provided a method of operating a ferry slip.

The present invention relates to ferry slip and a ferry.

### BACKGROUND

For various ships, for example ferries, a significant amount of time is spent docking the vessel at the slip or wharf, and setting the vessel in motion again for the next trip. The energy consumption during the operations associated with steering the vessel to the slip or wharf is also significant. This can be further increased in poor weather conditions, with wind or sea currents. It is desirable to minimize the time and energy required for such docking operations.

The present invention has the objective to provide a system and method which provides advantages over known solutions and techniques.

### SUMMARY

In an embodiment, there is provided a ferry slip comprising a vehicle driveway arranged on a quayside, the ferry slip comprising an elongate fluid cylinder unit connected to the quayside and extending longitudinally away from the quayside in a seawards direction, the fluid cylinder unit having a support element at its seawards end, the fluid cylinder unit fluidly connected to an accumulator unit via a fluid distribution system.

In an embodiment, the elongate fluid cylinder unit is arranged substantially horizontally.

In an embodiment, the ferry slip comprises a ramp, wherein the vehicle driveway extends from the quayside onto the ramp, and wherein the ramp is vertically movable by means of a ramp lifting device.

In an embodiment, the ferry slip comprises a fluid power unit fluidly connected to the fluid distribution system. The fluid power unit may be configured to generate fluid power and supply the fluid power to the accumulator unit via the fluid distribution system.

In an embodiment, the ferry slip comprises an electronic control unit. The electronic control unit may be configured to control the distribution of fluid in the fluid distribution system.

In an embodiment, the ferry slip comprises a lifting device arranged to move the fluid cylinder unit in the vertical direction.

In an embodiment, the lifting device comprises a first lifting unit arranged to engage the fluid cylinder unit at a quayside half of the fluid cylinder unit and a second lifting unit arranged to engage the fluid cylinder unit at a seawards half of the fluid cylinder unit.

In an embodiment, the first and second lifting units are configured to maintain the fluid cylinder unit in a horizontal arrangement.

In an embodiment, the ferry slip comprises a support frame connected to the fluid cylinder unit and configured to support the fluid cylinder unit in at least one of (i) a vertical direction and (ii) a direction transverse on the seawards direction.

In an embodiment, the support frame is movable in the seawards direction along a frame structure.

In an embodiment, there is provided a method of operating a ferry slip according to any one of the above embodiments, comprising the steps of: bringing the support element into engagement with a ferry; applying a braking force from the fluid cylinder unit on the ferry via the support element while allowing the ferry to move a first distance in a direction parallel to the seawards direction; generating a braking energy in the fluid cylinder unit; and transferring the braking energy from the fluid cylinder unit to the accumulator unit via the fluid distribution system.

In an embodiment, the method comprises the steps of: transferring an acceleration energy from the accumulator unit to the fluid cylinder unit via the fluid distribution system; applying an acceleration force from the fluid cylinder unit on the ferry via the support element while moving the ferry a second distance in a direction parallel to the seawards direction.

In an embodiment, the first distance is: (i) larger than, (ii) smaller than, or (iii) identical to the second distance; and/or the braking energy is: (i) higher than the acceleration energy or (ii) lower than the acceleration energy; and/or the braking force is: (i) higher than the acceleration force or (ii) lower than the acceleration force, and/or the average braking force over the first distance is: (i) higher than the average acceleration force over the second distance or (ii) lower than the average acceleration force over the second distance.

In an embodiment, the method comprises the steps: operating a sensor to provide a parameter representative of a velocity of the ferry; and adjusting at least one of: (i) a fluid pressure in the accumulator unit, and (ii) the first distance as a function of the parameter.

In an embodiment, the ferry has a hybrid-electric or a full-electric propulsion plant.

### BRIEF DESCRIPTION OF THE DRAWINGS

Illustrative embodiments of the present invention will now be described with reference to the appended drawings, in which:

FIGS. 1-3 illustrate an embodiment of a ferry slip,

FIG. 4 illustrates an embodiment of a ferry slip,

FIG. 5 illustrates details of a fluid distribution system, and

FIGS. 6A and 6B illustrate steps in the operation of a ferry slip.

### DETAILED DESCRIPTION

Ferry services are used in various transport links, such as for cars, trains, or other types of vehicles. The process of docking the ferry at the ferry slip usually requires significant time and energy, as braking and maneuvering must be done with the propulsion machinery to dock the ferry in the correct position. In particular for short ferry transport links, the time and energy consumed during docking may make up a proportionally large fraction of the total operating time and energy consumption.

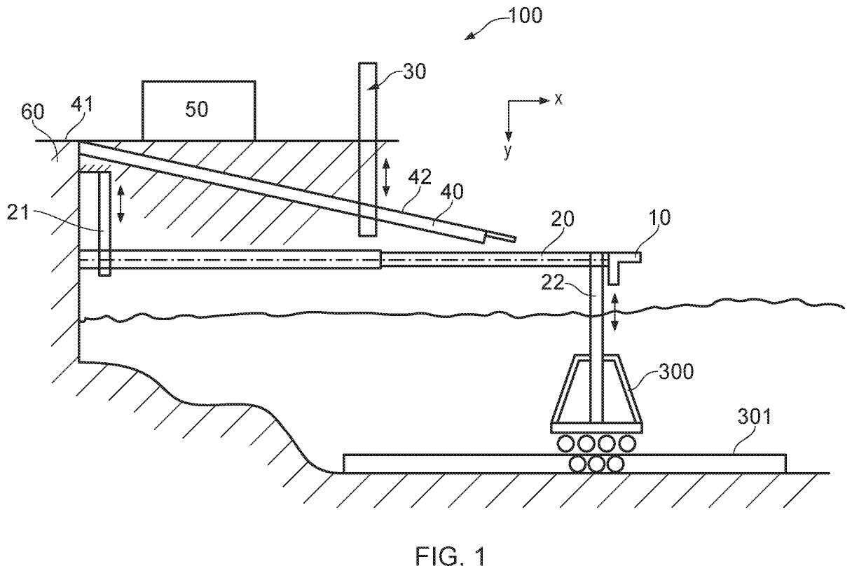

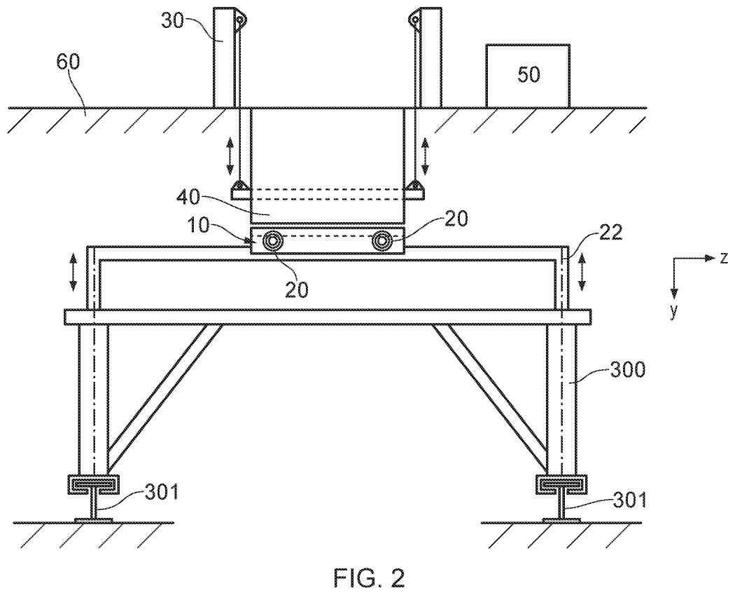

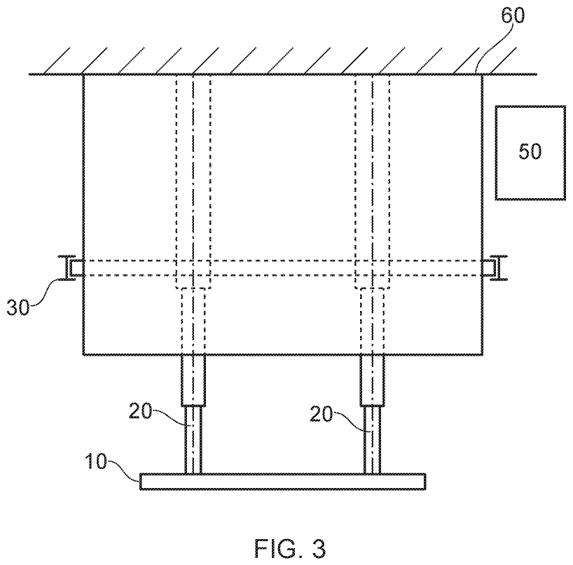

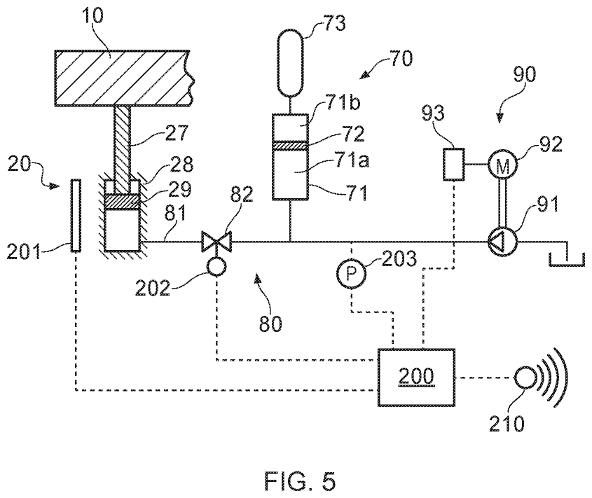

In an embodiment, illustrated in FIGS. 1-3, there is provided a ferry slip 100 comprising a vehicle driveway 41 arranged on a quayside 60. The ferry slip 100 has an elongate fluid cylinder unit 20 which in one end is connected to the quayside 60 and extends longitudinally away from the quayside 60 in a seawards direction x. The fluid cylinder unit 20 has a support element 10 at its seawards end. The fluid cylinder unit 20 is fluidly connected to an accumulator unit 70 via a fluid distribution system 80 (described in further detail in relation to FIG. 5 below). The fluid cylinder unit 20 has a hydraulic cylinder. The hydraulic cylinder may be of any type, such as a piston operating in a cylinder (as schematically illustrated in FIG. 5) or a telescopic hydraulic cylinder (see FIGS. 1, 3 and 4) with any number of telescopic cylinder sections according to the requirements at hand.

The elongate fluid cylinder unit 20 is arranged so as to extend away from the quayside in a substantially horizontal arrangement.

The ferry slip 100 has a ramp 40 fixed with one end to the quayside 60. The vehicle driveway 41 extends from the quayside 60 onto the ramp 40 such as to form an extension 42 of the driveway. The ramp 40 is vertically movable by means of a ramp lifting device 30, such that the second end of the ramp 40 may be brought into alignment with a ferry deck at varying tidal conditions or varying draught/freeboard of the ferry. The ramp lifting device 30 may be connected to and powered from the fluid distribution system 80.

A lifting device 21,22 is arranged to move the fluid cylinder unit 20 in the vertical direction. The lifting device 21,22 comprises a first lifting unit 21 arranged to engage the fluid cylinder unit 20 at a quayside half or a quayside end of the fluid cylinder unit 20 and a second lifting unit 22 arranged to engage the fluid cylinder unit 20 at a seawards half or seawards end of the fluid cylinder unit 20. The first and second lifting units 21,22 may be hydraulic cylinders. The first and second lifting units may be connected to and powered from the fluid distribution system 80.

The first and second lifting units 21,22 are configured to maintain the fluid cylinder unit 20 in a horizontal arrangement.

The ferry slip 100 further has a support frame 300 connected to the fluid cylinder unit 20 and configured to support the fluid cylinder unit 20 the vertical direction y and/or the sideways direction, i.e. a direction transverse on the seawards direction x and on the longitudinal direction of the fluid cylinder unit. The support frame 300 is movable in the seawards direction x, i.e. in the longitudinal direction of the fluid cylinder unit 20, along a frame structure 301. The frame structure 301 may be a beam or a track or the like, and the support frame 300 may be provided with slider bearings, roller bearings, or any other suitable type of bearing or connection to permit movement of the support frame 300 along the frame structure 301.

The ferry slip 100 further has an accumulator station 50, housing the accumulator unit 70, a fluid power unit 90 and parts of the fluid distribution system 80. The fluid distribution system 80 extends out of the accumulator station 50 to connect to the relevant external components.

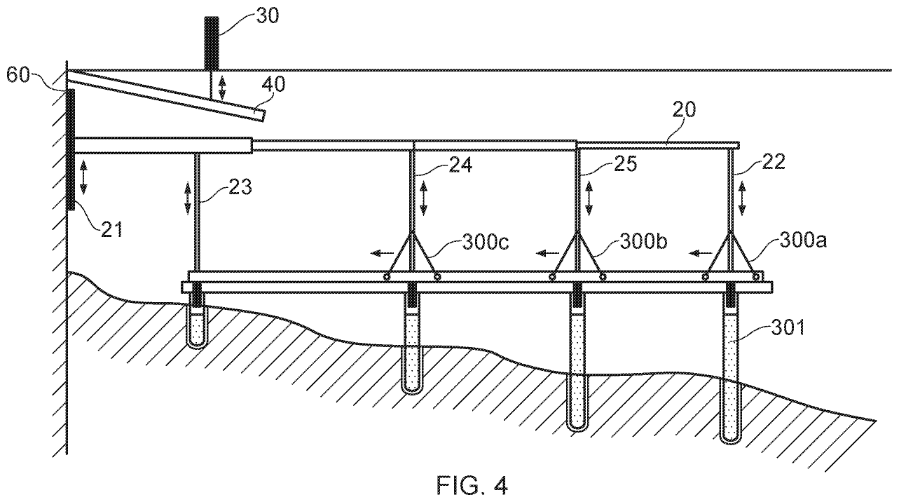

FIG. 4 illustrates another embodiment, in which the frame structure 301 is arranged on several pillars and a plurality of support frames 300a-c are arranged to support the hydraulic cylinder unit 20 at different positions along its longitudinal length and a plurality of lifting units 21-25 are arranged similarly.

FIG. 5 illustrates schematically parts of the hydraulic system. The hydraulic cylinder unit 20 has a piston 29 operating in a cylinder 28, with a piston rod 27 extending out of the cylinder 28 and connected to the support element 10. Alternatively, the hydraulic cylinder unit 20 may have a telescopic cylinder. The hydraulic cylinder unit 20 is fluidly connected to a hydraulic distribution line 81. A valve 82 having a valve actuator 202 is provided in the hydraulic distribution line 81 such as to allow opening, closing or adjustment of the hydraulic fluid flow to or from the hydraulic cylinder unit 20.

The accumulator unit 70 is also fluidly connected to the hydraulic distribution line 81. The accumulator unit 70 has an accumulator cylinder 71 having a liquid side 71a and a gas side 71b. A piston 72 separates the gas side 71b and the liquid side 71a in the conventional manner. A gas storage unit 73, such as one or more gas bottles, is provided and arranged fluidly connected to the gas side 71b. By providing a pressurized gas in the gas side 71b of the accumulator cylinder 71 and in the gas storage unit 73, the accumulator unit 70 maintains a substantially constant hydraulic pressure in the hydraulic distribution line 81. The accumulator unit 70 further absorbs energy if hydraulic fluid is provided to the accumulator cylinder 71 from the hydraulic distribution line 81, the absorbed energy being stored in the form of compression energy on the gas side 71b and in the gas storage unit 73. Similarly, the accumulator unit 70 can supply energy to the hydraulic distribution line 81 by means of supplying pressurized hydraulic fluid if the pressure in the hydraulic fluid line 81 drops. The work for this is provided by the compressed gas.

The fluid power unit 90 is also fluidly connected to the hydraulic fluid line 81. The fluid power unit 90 comprises a hydraulic pump 91 driven by a motor 92. The motor 92 is in this embodiment an electric motor, which is controlled by a motor controller 93.

An electronic control unit 200 is arranged to control various components of the system. The electronic control unit 200 receives various inputs, including a position measurement of the hydraulic cylinder unit 20 from a position sensor 201 and a pressure measurement of the hydraulic distribution line 81 provided by a pressure sensor 203. Further sensor may be arranged as required. The position sensor 201 measures the extension of the hydraulic cylinder unit 20, and may be any sensor capable of measuring this directly or indirectly, for example a linear encoder.

The electronic control unit 200 further provides control signals to various actuators, including the valve actuator 202 and the motor controller 93.

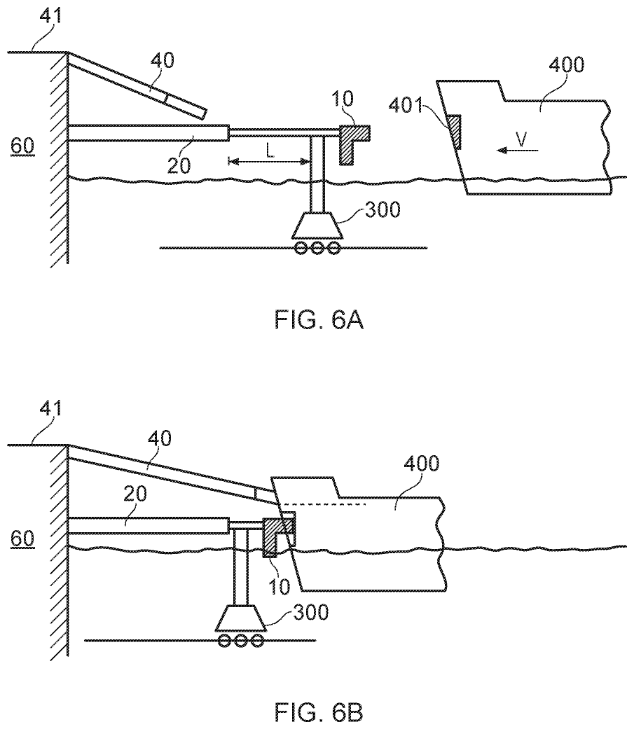

An example of the operation of a ferry will now be described with reference to FIGS. 6A and 6B, which illustrate in a simplified manner a ferry slip 100 according to any of the embodiments described above.

A ferry 400 approaches the ferry slip 100 with a velocity v as indicated in FIG. 6A. The ferry 400 has a certain motion energy due to its speed, and needs to be brought to a standstill and connected to the ramp 40 for unloading and loading of vehicles, passengers, etc. As the ferry 400 reaches the ferry slip 100, it is brought into contact with the support element 10. The contact may be in the form of the support element 10 resting against a support surface 401, for example a recess in the body of the ferry 400, or it may be a fixed connection, e.g. that the support element 10 goes into an interlocking engagement with a corresponding unit on the ferry 400.

The electronic control unit 200 is arranged to control the operation of the hydraulic arrangement, including the operation of the valve 82, the fluid power unit 90, and all other relevant components. This may include various other aspects, such as controlling the position of the hydraulic cylinder unit 20 in the absence of any force acting on it (e.g. prior to engagement with the ferry 400), the operation of the fluid power unit 90, etc.

As the ferry 400 moves further towards the quayside 60, a braking force will be applied to the ferry 400 through the support element 10 and hydraulic cylinder unit 20. The magnitude of the braking force will be determined by the pressure in the hydraulic distribution line 81 (see FIG. 5). The braking force will be applied over a distance I, until the ferry 400 comes to a standstill, at which time the ramp 40 may be lowered to the ferry 400 deck. This situation is shown in FIG. 6B.

The energy generated by the braking force will be transmitted from the hydraulic cylinder unit 20, via the fluid distribution system 80, to the accumulator unit 70. This energy is thereby not lost.

Since the hydraulic cylinder unit 20 is arranged in the seawards direction and substantially horizontally, the direction of motion of the ferry 400 during the braking process is substantially parallel to the longitudinal direction of the hydraulic cylinder unit 20. This ensures that the hydraulic cylinder unit 20 is not subjected to sideways, rotational, or bending forces, which may damage the cylinder. This also permits a longer cylinder to be used, i.e. having a longer stroke length, whereby a larger amount of braking energy can be recovered. The support structure, with the support frame 300 and the frame structure 301 provides the same effects.

This permits the ferry 400 to have higher velocity when approaching the ferry slip 100, and reduces the time required for docking. In one embodiment, a sensor 210 (see FIG. 5) is provided to measure the velocity v of the ferry 400 as it is approaching the ferry slip 100. The sensor 210 may be an optical position sensor, such as a lidar system, or any other sensor suitable for this purpose. The sensor 200 may be a quayside sensor or, alternatively or additionally, a sensor arranged on the ferry 400. The sensor reading is provided as a parameter to the control unit 200 in advance of the ferry 400 reaching the ferry slip 100, and at least one of (i) a fluid pressure in the accumulator unit 70 and (ii) the first distance I is adjusted as a function of the parameter. The electronic control unit 200 can then be operated to adjust the hydraulic pressure supplied to the hydraulic cylinder unit 20 and/or the initial extension of the hydraulic cylinder unit 20 such as to bring the ferry 400 to a stop at the correct position. Alternatively, the parameter may be provided to an operator, for example on an operating display, and the adjustment or adjustments may be done manually.

In an embodiment, operation of the system may further comprise the step of applying an acceleration force from the support element (10) to the ferry 400 when the ferry 400 is to leave the ferry slip 100, thus transferring an acceleration energy from the accumulator unit 70 to the ferry 400 via the fluid distribution system 80 and the fluid cylinder unit 20. This reduces the need for the ferry 400 to use propulsive power when leaving the ferry slip 100. The acceleration force may be sufficiently high to provide fast acceleration and thus reducing the time required for the ferry 400 to leave the ferry slip 100. This also permits the use of stored braking energy for ferry acceleration, thereby recovering this energy and reducing energy losses.

The distance over which the hydraulic cylinder unit 20 provides braking and acceleration forces on the ferry 400 may be adjusted according to the needs of a specific case, the maximum force and/or acceleration permitted, or the energy required or desired to be transferred. These may be identical. Alternatively, more acceleration energy may be provided than the braking energy recovered. This may be achieved by operating the fluid power unit 90 to add additional hydraulic energy to the accumulator unit 70 and applying a higher acceleration force than the braking force, and/or applying the acceleration force over a longer distance than the braking force. This may reduce the overall on-vessel energy consumption, since a larger fraction of the propulsion energy is provided from shore.

Alternatively, more braking energy may be recovered than the acceleration energy provided. This may be achieved by applying a higher braking force than the acceleration force, and/or applying the braking force over a longer distance than the acceleration force. Recovering more braking energy ensures that this energy is not lost, thereby improving overall energy efficiency, and reduces the need for the ferry 400 to maneuver and operate the propulsion machinery at high power at or near the ferry slip 100, which may erode the seafloor and be disadvantageous for other reasons, such as noise pollution. Moreover, this may allow the ferry to be designed with lower maximum installed propulsion power, since the need for heavy maneuvering while docking will be reduced.

In one embodiment, the ferry 400 is a hybrid-electric ferry or a full-electric ferry. A hybrid-electric ferry has a propulsion plant which comprises an electric driveline, powered by a combination of stored electric energy and energy supplied by a combustion engine. A full-electric ferry has a propulsion plant which comprises an electric driveline, powered substantially exclusively by stored electric energy. According to embodiments disclosed herein, the hybrid-electric or full-electric ferry may thus be designed with lower installed electric energy storage, reducing the construction cost and complexity of the ferry.

According to embodiments disclosed herein, it is therefore possible to, for example, optimize the operation of a ferry 400 such as to minimize the time spent docking at the ferry slip 100, thereby maximizing the utilization of the ferry. Further, energy consumption can be reduced through recovery of braking energy and/or minimizing the need for maneuvering while docking. Supply of energy from shore instead of generating it or storing it onboard may improve overall energy efficiency, permit the use of sustainable or renewable energy sources, and simplify vessel and propulsion plant design (e.g. reduce the max. installed power).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

The present invention is not limited to the embodiments described herein. Reference should be had to the appended claims.

1. A ferry slip comprising:
a vehicle driveway arranged on a quayside, and
an elongate fluid cylinder unit connected to the quayside and extending longitudinally away from the quayside in a seawards direction (x), the elongate fluid cylinder unit having a support element at its seawards end,
wherein the support element is configured to be brought into contact with a ferry approaching the ferry slip and bring the ferry to a standstill, and
the fluid cylinder unit is fluidly connected to an accumulator unit via a fluid distribution system.

2. The ferry slip according to claim 1, wherein the elongate fluid cylinder unit is arranged substantially horizontally.

3. The ferry slip according to claim 1, further comprising a ramp, wherein the vehicle driveway extends from the quayside onto the ramp, and wherein the ramp is vertically movable by means of a ramp lifting device.

4. The ferry slip according to claim 1, further comprising a fluid power unit fluidly connected to the fluid distribution system.

5. The ferry slip according to claim 1, further comprising an electronic control unit.

6. The ferry slip according to claim 1, further comprising a lifting device arranged to move the fluid cylinder unit in the vertical direction.

7. The ferry slip according to claim 1, wherein the lifting device comprises a first lifting unit arranged to engage the fluid cylinder unit at a quayside half of the fluid cylinder unit and a second lifting unit arranged to engage the fluid cylinder unit at a seawards half of the fluid cylinder unit.

8. The ferry slip according to claim 7, wherein the first and second lifting units are configured to maintain the fluid cylinder unit in a horizontal arrangement.

9. The ferry slip according to claim 1, further comprising a support frame connected to the fluid cylinder unit and configured to support the fluid cylinder unit in at least one of
a vertical direction (y) and
a direction transverse on the seawards direction (x).

10. The ferry slip according to claim 9, wherein the support frame is movable in the seawards direction (x) along a frame structure.

11. A method of operating the ferry slip according to claim 1, comprising:
bringing the support element into engagement with a ferry,
applying a braking force from the fluid cylinder unit on the ferry via the support element while allowing the ferry to move a first distance in a direction parallel to the seawards direction (x),
generating a braking energy in the fluid cylinder unit, and
transferring the braking energy from the fluid cylinder unit to the accumulator unit via the fluid distribution system.

12. The method according to claim 11, further comprising:
transferring an acceleration energy from the accumulator unit to the fluid cylinder unit via the fluid distribution system,
applying an acceleration force from the fluid cylinder unit on the ferry via the support element while moving the ferry a second distance in a direction parallel to the seawards direction (x).

13. The method according to claim 12, wherein:
the first distance is: (i) larger than, (ii) smaller than, or (iii) identical to the second distance; and/or
the braking energy is: (i) higher than the acceleration energy or (ii) lower than the acceleration energy; and/or
the braking force is: (i) higher than the acceleration force or (ii) lower than the acceleration force, and/or
the average braking force over the first distance is: (i) higher than the average acceleration force over the second distance or (ii) lower than the average acceleration force over the second distance.

14. The method according to claim 11, further comprising:
operating a sensor to provide a parameter representative of a velocity of the ferry,
adjusting at least one of: (i) a fluid pressure in the accumulator unit, and (ii) the first distance as a function of the parameter.

15. The method according to claim 11, wherein the ferry has a hybrid-electric or a full-electric propulsion plant.
